(19) United States
(12) Patent Application Publication
(10) Pub. No.: US 2023/0402604 A1
(43) Pub. Date: Dec. 14, 2023

(54) SOLID-STATE BATTERY NEGATIVE ELECTRODE, SOLID-STATE BATTERY, AND METHOD FOR MANUFACTURING SOLID-STATE BATTERY NEGATIVE ELECTRODE

(71) Applicants: Panasonic Holdings Corporation, Osaka (JP); HONDA MOTOR CO., LTD., Tokyo (JP)

(72) Inventors: Mitsuhiro Murata, Hyogo (JP); Kazufumi Otani, Kanagawa (JP); Terumi Furuta, Saitama (JP); Masahiro Takehara, Tokyo (JP); Hiroshi Ito, Osaka (JP)

(21) Appl. No.: 18/227,736

(22) Filed: Jul. 28, 2023

Related U.S. Application Data
(63) Continuation of application No. PCT/JP22/02485, filed on Jan. 24, 2022.

(30) Foreign Application Priority Data
Feb. 1, 2021 (JP) 2021-014623

(51) Int. Cl. H01M 4/587; H01M 10/0562; H01M 4/133; H01M 4/04; H01M 4/1393

(52) U.S. Cl. CPC H01M 4/587; H01M 10/0562; H01M 4/133; H01M 4/0433; H01M 4/1393; H01M 2004/021

(57) ABSTRACT

A solid-state battery negative electrode of the present disclosure includes a negative electrode active material layer, the negative electrode active material layer including a negative electrode active material and a solid electrolyte. The negative electrode active material in the negative electrode active material layer has an average aspect ratio of more than 0.5. The negative electrode active material has an average elastic modulus of 370 MPa or less. A solid-state battery of the present disclosure includes: a positive electrode; a negative electrode; and a solid electrolyte layer provided between the positive electrode and the negative electrode. The negative electrode is the solid-state battery negative electrode.

This application is a continuation of PCT/JP2022/002485 filed on Jan. 24, 2022, which claims foreign priority of Japanese Patent Application No. 2021-014623 filed on Feb. 1, 2021, the entire contents of both of which are incorporated herein by reference.

### BACKGROUND OF THE INVENTION

### 1. Field of the Invention

The present disclosure relates to a solid-state battery negative electrode, a solid-state battery, and a method for manufacturing a solid-state battery negative electrode.

### 2. Description of Related Art

In recent years, research and development have been actively conducted on all-solid-state batteries using a solid electrolyte. JP 2019-16484 A discloses an all-solid-state battery including a negative electrode in which a negative electrode mixture layer includes graphite particles in a high content, 70 mass % or more and 90 mass % or less.

WO 2014/016907 A1 discloses an all-solid-state battery in which a graphite included in a negative electrode active material layer has a hardness of 0.36 GPa or more.

### SUMMARY OF THE INVENTION

The present disclosure provides a solid-state battery negative electrode with suppressed ion transport resistance.

A solid-state battery negative electrode of the present disclosure includes
a negative electrode active material layer, the negative electrode active material layer including a negative electrode active material and a solid electrolyte, wherein
the negative electrode active material in the negative electrode active material layer has an average aspect ratio of more than 0.5, and
the negative electrode active material has an average elastic modulus of 370 MPa or less.

The present disclosure provides a solid-state battery negative electrode with suppressed ion transport resistance.

### BRIEF DESCRIPTION OF THE DRAWINGS

FIG. 1 is a schematic cross-sectional view showing the state, during the charge operation of an all-solid-state lithium-ion secondary battery, in which lithium ions and electrons are transported and diffuse in a negative electrode active material layer.

FIG. 2 is a cross-sectional view schematically showing the configuration of an all-solid-state lithium-ion secondary battery negative electrode of Embodiment 1.

FIG. 3 is a cross-sectional view schematically showing the configuration of an all-solid-state lithium-ion secondary battery of Embodiment 2.

FIG. 4A is an illustrative diagram showing the method for determining the aspect ratio of a negative electrode active material of Embodiment 1.

FIG. 4B is an illustrative diagram showing the method for calculating the orientation angle of the negative electrode active material of Embodiment 1.

FIG. 5 is an illustrative diagram showing the mechanism of occurrence of spring back of the negative electrode active material layer of Embodiment 1.

FIG. 6A is an FE-SEM image of a negative electrode active material layer including a negative electrode active material of Comparative Example 1.

FIG. 6B is a binary image obtained by binarizing the FE-SEM image shown in FIG. 6A.

FIG. 7 is a cross-sectional view schematically showing the configuration of a symmetric cell for use in measurement of ion transport resistance.

FIG. 8 is a graph showing the Cole-Cole plot obtained by an impedance measurement of the symmetric cell shown in FIG. 7.

FIG. 9 is a diagram showing the equivalent circuit of the symmetric cell shown in FIG. 7 in the impedance measurement shown in FIG. 8.

FIG. 10 is a graph showing the relation between the pressing pressure and a resistance value Wo-R of the Warburg open circuit for symmetric cells of Comparative Example 1 and Comparative Example 4.

FIG. 11 is a graph showing the relation between the constraining pressure and the resistance value Wo-R of the Warburg open circuit for the symmetric cells of Comparative Example 1 and Comparative Example 4.

FIG. 12A is a graph showing the results of a charge rate test at 25° C. for batteries of Comparative Example 5 and Example 5.

FIG. 12B is a graph showing the results of a charge rate test at 60° C. for the batteries of Comparative Example 5 and Example 5.

FIG. 13A is a graph showing the results of a charge rate test at 25° C. for batteries of Examples 6 to 9.

FIG. 13B is a graph showing the relation between the volume ratio of the negative electrode active material and the capacity retention rate for the batteries of Examples 6 to 9.

### DETAILED DESCRIPTION

(Findings on which the Present Disclosure is Based)

Lithium-ion secondary batteries are composed of a positive electrode, a negative electrode, and an electrolyte disposed between them. The electrolyte is a non-aqueous liquid or solid. However, since widely used electrolyte solutions are combustible, lithium-ion batteries using an electrolyte solution need to be equipped with a system for ensuring safety. On the other hand, since solid electrolytes are incombustible, such a system can be simplified. Accordingly, various lithium-ion secondary batteries using a solid electrolyte (hereinafter referred to as all-solid-state lithium-ion secondary batteries) have been proposed.

Lithium-ion secondary batteries using an electrolyte solution and all-solid-state lithium-ion secondary batteries greatly differ from each other in terms of method for forming the lithium-ion conduction path in the electrode. In lithium-ion secondary batteries using an electrolyte solution, an electrolyte solution is immersed into gaps between active materials after electrode molding thus to form a lithium-ion conduction path. On the other hand, in all-solid-state lithium-ion secondary batteries, an active material, a solid electrolyte, and a binder and are kneaded and pressure-molded thus to form a lithium-ion conduction path.

Lithium-ion secondary batteries using an electrolyte solution and all-solid-state lithium-ion secondary batteries greatly differ from each other also in terms of transport mechanism of lithium ions from the electrolyte to the active material. In lithium-ion secondary batteries using an electrolyte solution, after a desolvation reaction of lithium ions, lithium ions are transported via an organic SEI layer formed on the surface of the electrode. On the other hand, in all-solid-state lithium-ion secondary batteries, lithium ions are transported by being extruded one after another from the solid electrolyte to the active material in a chain reaction manner.

From the above two differences, all-solid-state lithium-ion secondary batteries have a technical problem different from that of lithium-ion secondary batteries using an electrolyte solution, and measures therefor are required.

The charge operation of all-solid-state lithium-ion secondary batteries is as follows. Lithium accumulated in the positive electrode active material in the positive electrode active material layer emits electrons thus to be ionized (that is, oxidized), and migrates from the positive electrode active material layer to the solid electrolyte layer via, as the path, the portion in the positive electrode active material layer where the particles of the solid electrolyte are continuous. The lithium ions, which have migrated from the solid electrolyte layer to the negative electrode active material layer, reach the negative electrode active material via, as the path, the portion in the negative electrode active material layer where the particles of the solid electrolyte are continuous. The lithium ions, which have reached the negative electrode active material, receive electrons from the negative electrode active material (that is, are reduced). In this manner, lithium diffuses from the solid electrolyte to the negative electrode active material and is accumulated in the negative electrode active material layer.

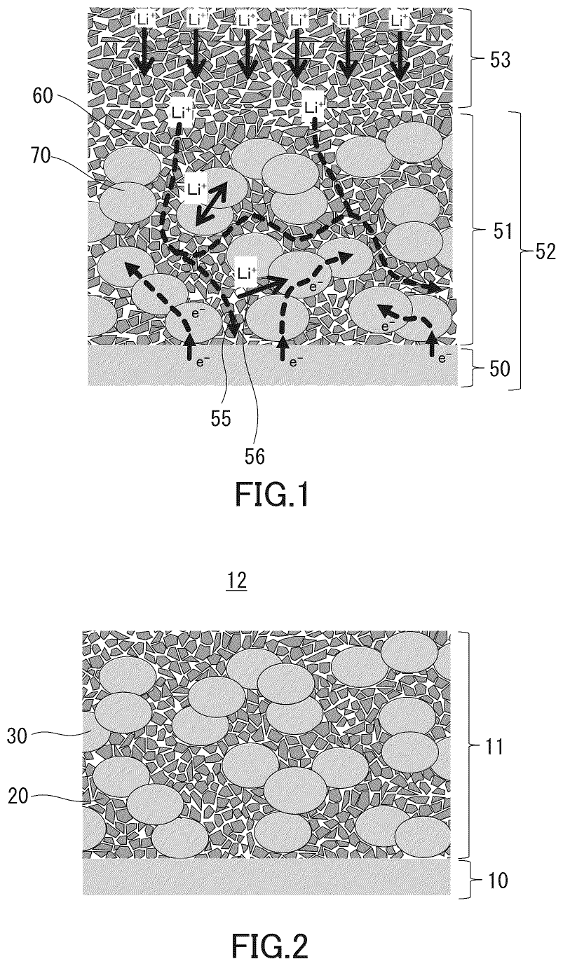

According to the mechanism of lithium-ion conduction in the charge operation of all-solid-state lithium-ion secondary batteries, the transport and diffusion of lithium ions in the negative electrode active material layer have been found to exert a significant influence on the charge rate performance. FIG. 1 shows the state, during the charge operation of an all-solid-state lithium-ion secondary battery, in which lithium ions and electrons are transported and diffuse in the negative electrode active material layer. As shown in FIG. 1, a negative electrode 52 includes a negative electrode current collector 50 and a negative electrode active material layer 51. The negative electrode active material layer 51 includes a negative electrode active material 70 and a solid electrolyte 60. A solid electrolyte layer 53 is disposed between the negative electrode 52 and the positive electrode (not shown). In FIG. 1, Li⁺ indicates lithium ions, and e⁻ indicates electrons.

The general negative electrode active material layer 51, such as shown in FIG. 1, has both an electron conduction path formed by contact between the particles of the negative electrode active material 70 and an ion conduction path formed by connection between the particles of the solid electrolyte 60. Major factors for a significant influence exerted on the charge rate performance of all-solid-state lithium-ion secondary batteries include the resistance to lithium-ion transport (hereinafter referred to as ion transport resistance) and the resistance to lithium diffusion from the solid electrolyte 60 to the negative electrode active material 70 (hereinafter referred to as reaction resistance). In FIG. 1, the ion transport resistance is represented by a dotted line indicated by reference numeral 55, and the reaction resistance is represented by a solid line indicated by reference numeral 56.

JP 2019-16484 A seeks an increase in capacity of the all-solid-state battery by, in the negative electrode mixture layer, reducing the content of the solid electrolyte that functions to transport lithium ions but does not have an electricity storage function and increasing the content of graphite particles having an electricity storage function. Furthermore, JP 2019-16484 A mentions that the specific surface area of the graphite particles is increased through surface roughening, so that the physical contact area can be increased between the graphite particles and the solid electrolyte in the negative electrode mixture layer, thereby reducing the contact resistance, that is, the reaction resistance.

WO 2014/016907 A1 mentions that, in the negative electrode active material layer, the hardness of the graphite on a micro scale by the nanoindentation method is set to be within a predetermined range, so that the relative proportion of the edge planes of the graphite is maintained for the case of constraint at a predetermined constraining pressure. That is, WO 2014/016907 A1 seeks a reduction in reaction resistance by suppressing the decrease of the edge planes on the graphite surface.

On the other hand, the present inventors have intensively studied to found that in order to achieve high capacity and high charge rate performance in all-solid-state lithium-ion secondary batteries, it is necessary to take measures to reduce the ion transport resistance rather than the reaction resistance. The ion transport resistance increases as the tortuosity of the ion conduction path shown in FIG. 1 increases. That is, in order to reduce the ion transport resistance, it is important to lower the tortuosity of the ion conduction path as much as possible. However, for example, as in JP 2019-16484 A, in the case where the composition ratio of graphite particles as the negative electrode active material is increased in order to increase the capacity, the proportion of the solid electrolyte that functions to transport lithium ions in the negative electrode active material layer is decreased. Consequently, the tortuosity of the ion conduction path is increased, and the ion transport resistance accordingly becomes more dominant over the charge rate performance than the reaction resistance does.

Based on the above findings, the present inventors have arrived at the solid-state battery negative electrode of the present disclosure with suppressed ion transport resistance.

### (Overview of One Aspect According to the Present Disclosure)

A solid-state battery negative electrode according to a first aspect of the present disclosure includes
a negative electrode active material layer, the negative electrode active material layer including a negative electrode active material and a solid electrolyte, wherein
the negative electrode active material in the negative electrode active material layer has an average aspect ratio of more than 0.5, and
the negative electrode active material has an average elastic modulus of 370 MPa or less.

According to the above configuration, it is possible to suppress the ion transport resistance of the negative electrode active material layer.

In a second aspect of the present disclosure, for example, in the solid-state battery negative electrode according to the first aspect, the average elastic modulus may be 59 MPa or more and 370 MPa or less. According to such a configuration, it is possible to avoid the generation of microcracks in the negative electrode active material layer due to volume expansion that is caused by pressure release after pressure molding, so-called spring back, in the negative electrode active material layer.

In a third aspect of the present disclosure, for example, in the solid-state battery negative electrode according to the first or second aspect, the average aspect ratio may be more than 0.5 and 0.8 or less. According to such a configuration, it is possible to further suppress the ion transport resistance of the negative electrode active material layer.

In a fourth aspect of the present disclosure, for example, in the solid-state battery negative electrode according to any one of the first to third aspects, the negative electrode active material layer may have a porosity of 30% or less. According to such a configuration, it is possible to achieve a solid-state battery with enhanced charge rate performance.

In a fifth aspect of the present disclosure, for example, in the solid-state battery negative electrode according to any one of the first to fourth aspects, a volume composition ratio of the negative electrode active material to a total volume of materials included in the negative electrode active material layer may be 50% or more and less than 70%. According to such a configuration, it is possible to suppress a significant deterioration in charge rate performance of the solid-state battery.

In a sixth aspect of the present disclosure, for example, in the solid-state battery negative electrode according to any one of the first to fifth aspects, the negative electrode active material may include a graphite. According to such a configuration, it is possible to easily control the tortuosity of the ion conduction path in the negative electrode active material layer.

In a seventh aspect of the present disclosure, for example, in the solid-state battery negative electrode according to any one of the first to sixth aspects, the solid electrolyte may include a solid sulfide electrolyte. According to such a configuration, it is possible to achieve an all-solid-state lithium-ion secondary battery with enhanced charge and discharge characteristics.

In an eighth aspect of the present disclosure, for example, in the solid-state battery negative electrode according to the seventh aspect, the solid sulfide electrolyte may include at least one selected from the group consisting of a Li₂S—P₂S₅-based glass-ceramic electrolyte and a solid argyrodite-type sulfide electrolyte. According to such a configuration, it is possible to achieve a solid-state battery with further enhanced charge and discharge characteristics.

A solid-state battery according to a ninth aspect of the present disclosure includes:
a positive electrode;
a negative electrode; and
a solid electrolyte layer provided between the positive electrode and the negative electrode, wherein
the negative electrode is the solid-state battery negative electrode according to any one of the first to eighth aspects.

According to the above configuration, it is possible to achieve high capacity and high charge rate performance in the solid-state battery.

A method for manufacturing a solid-state battery negative electrode according to a tenth aspect of the present disclosure, the method including:
mixing a negative electrode active material and a solid electrolyte to prepare a negative electrode mixture; and
pressure-molding the negative electrode mixture to obtain a negative electrode active material layer, wherein
the pressure-molding the negative electrode mixture is performed so that the negative electrode active material in the negative electrode active material layer has an average aspect ratio of more than 0.5, and
the negative electrode active material used is a negative electrode active material having an average elastic modulus of 370 MPa or less.

According to the above configuration, it is possible to suppress the ion transport resistance of the negative electrode active material layer.

Embodiments of the present disclosure will be described below with reference to the drawings.

### Embodiment 1

FIG. 2 is a cross-sectional view schematically showing the configuration of an all-solid-state lithium-ion secondary battery negative electrode of Embodiment 1.

### [All-Solid-State Lithium-Ion Secondary Battery Negative Electrode 12]

An all-solid-state lithium-ion secondary battery negative electrode 12 of Embodiment 1 includes a negative electrode current collector 10 and a negative electrode active material layer 11. The negative electrode active material layer 11 is in contact with the negative electrode current collector 10. The negative electrode active material layer 11 includes a solid electrolyte 20 and a negative electrode active material 30. The particles of the solid electrolyte 20 and the particles of the negative electrode active material 30 are mixed and compressed thus to form the negative electrode active material layer 11.

### [Negative Electrode Current Collector 10]

The negative electrode current collector 10 is formed of a conductive material. Examples of the conductive material include a metal, a conductive oxide, a conductive nitride, a conductive carbide, a conductive boride, and a conductive resin.

### [Negative Electrode Active Material Layer 11]

The negative electrode active material layer 11 is a layer in which the negative electrode active material 30 and the solid electrolyte 20 are mixed in a predetermined volume composition ratio and dispersed. The negative electrode active material layer 11 has, as shown in FIG. 1, both an electron conduction path formed by contact between the particles of the negative electrode active material 30 and an ion conduction path formed by connection between the particles of the solid electrolyte 20.

The negative electrode active material layer 11 may have a porosity of 30% or less. According to the above configuration, it is possible to achieve an all-solid-state lithium-ion secondary battery with enhanced charge rate performance. The negative electrode active material layer 11 may have a porosity of 15% or less. It is desirable that the porosity of the negative electrode active material layer 11 should be as low as possible. The method for calculating the porosity of the negative electrode active material layer 11 will be described later.

The volume composition ratio of the negative electrode active material 30 to the total volume of the materials included in the negative electrode active material layer 11 may be 50% or more and less than 70%. In the case where the volume composition ratio of the negative electrode active material 30 is 50% or more and less than 70%, it is possible to suppress a significant deterioration in charge rate performance of all-solid-state lithium-ion secondary batteries. The volume composition ratio of the negative electrode active material 30 may be 50% or more and less than 60%. In the case where only the solid electrolyte 20 and the negative electrode active material 30 are included in the negative electrode active material layer 11, the volume composition ratio of the negative electrode active material 30 is the ratio to the sum of the volume of the solid electrolyte 20 and the volume of the negative electrode active material 30.

The negative electrode active material layer 11 may have an ion transport resistance of 17 Ω·cm² or less or 16 Ω·cm² or less. According to the above configuration, it is possible to achieve an all-solid-state lithium-ion secondary battery with suppressed ion transport resistance.

The ion transport resistance and other measured values as used herein refer to values measured at normal temperature (20±15° C.). The ion transport resistance (Ω×cm²) can be converted into the resistivity (Ω×cm). The resistivity can be calculated by dividing the ion transport resistance by the thickness of the negative electrode active material layer 11.

The negative electrode active material layer 11 may include a conductive additive, a binder, and the like as necessary.

The conductive additive only needs to be an electronically conductive material, and is not particularly limited. Examples of the conductive additive include a carbon material, a metal, and a conductive polymer. Examples of the carbon material include a graphite, such as natural graphite (e.g., massive graphite and flake graphite) and artificial graphite, acetylene black, carbon black, Ketjenblack, a carbon whisker, needle coke, and a carbon fiber. Examples of the metal include copper, nickel, aluminum, silver, and gold. These materials may be used alone or in combination as a mixture of two or more thereof. The conductive additive contributes to reducing the resistance of the negative electrode active material layer 11 to electrons.

The binder only needs to serve to hold the active material particles and the conductive additive particles, and is not particularly limited. Examples of the binder include a fluorine-including resin, such as polytetrafluoroethylene (PTFE), polyvinylidene fluoride (PVdF), and a fluorine rubber, a thermoplastic resin, such as polypropylene and polyethylene, ethylene propylene diene monomer (EPDM) rubber, sulfonated EPDM rubber, and natural butyl rubber (NBR). These materials may be used alone or in combination as a mixture of two or more thereof. The binder may be, for example, an aqueous dispersion of a cellulosic material or styrene-butadiene rubber (SBR). The binder exhibits an effect of maintaining the shape of the negative electrode active material layer 11.

Examples of the solvent in which the negative electrode active material 30, the solid electrolyte 20, the conductive agent, and the binder are dispersed include N-methylpyrrolidone, dimethylformamide, dimethylacetamide, methyl ethyl ketone, cyclohexanone, methyl acetate, methyl acrylate, diethylenetriamine, N,N-dimethylaminopropylamine, ethylene oxide, and tetrahydrofuran. For example, a dispersant and/or a thickener may be further added to the solvent. Examples of the thickener include carboxymethyl cellulose (CMC) and methyl cellulose.

The negative electrode active material layer 11 may have a thickness of 5 μm or more and 200 μm or less. In widely and generally used wet coating processes, for example, with an applicator or by die coating, the lower limit for thickness control on the coating film is 10 μm. From this point, the lower limit for film thickness after drying is generally suggested to be 5 μm, depending on the proportion of the solid component in the coating slurry. By appropriately adjusting the thickness of the negative electrode active material 11, it is possible to prevent electrode breakage during the drying, thereby enhancing the yield. In the case where a high-capacity material, such as silicon, is used as the material of the negative electrode active material 30, the thickness of the negative electrode active material layer 11 can be reduced to 10 μm or less.

### (Negative Electrode Active Material 30)

The negative electrode active material 30 is a material having properties of occluding and releasing lithium ions.

The negative electrode active material 30 in the negative electrode active material layer 11 may have an average aspect ratio of more than 0.5. The negative electrode active material 30 in the negative electrode active material layer 11 may have an average aspect ratio of 1 or less or 0.8 or less.

As shown in FIG. 2, lithium ions that have reached the negative electrode active material layer 11 from the positive electrode active material layer (not shown) via the solid electrolyte layer (not shown) migrate through the negative electrode active material layer 11 along the ion conduction path formed by connection between the particles of the solid electrolyte 20, and are accumulated in the negative electrode active material 30. The higher the degree of deformation of the negative electrode active material 30 in the pressure direction is, the higher tortuosity of the ion conduction path is. That is, the tortuosity of the ion conduction path tends to increase depending on the degree of deformation of the negative electrode active material 30. In the case where the negative electrode active material 30 in the negative electrode active material layer 11 obtained by pressure molding has an average aspect ratio of more than 0.5, the tortuosity of the ion conduction path is suppressed and the ion transport resistance of the negative electrode active material layer 11 is accordingly suppressed. Consequently, high capacity and high charge rate performance can be achieved in all-solid-state lithium-ion secondary batteries.

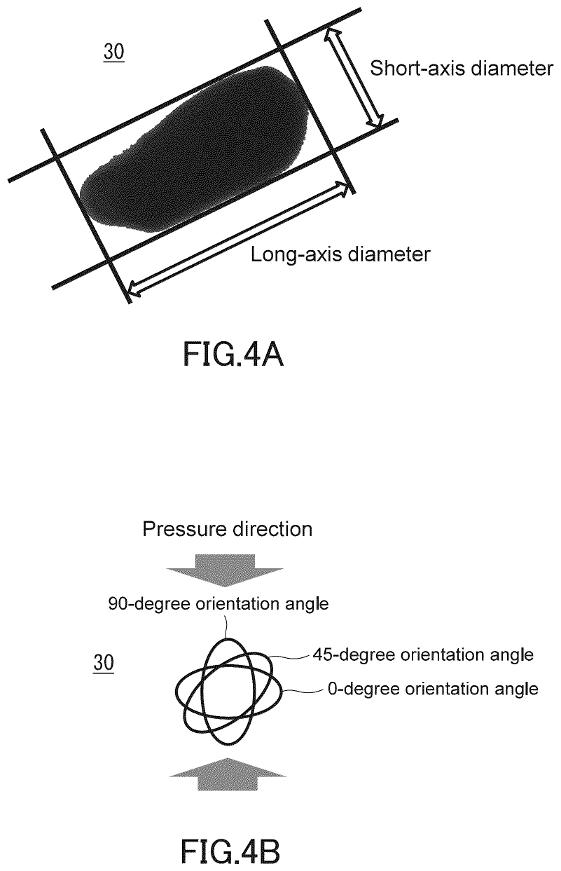

FIG. 4A is an illustrative diagram showing the method for determining the aspect ratio of the negative electrode active material 30. The aspect ratio of the negative electrode active material 30 is the ratio of the short-axis diameter to the long-axis diameter of the negative electrode active material 30 in the negative electrode active material layer 11 obtained by pressure molding, and is represented as short-axis diameter/long-axis diameter. As shown in FIG. 4A, from among pairs of parallel lines sandwiching the contour of the negative electrode active material 30 therebetween, one pair of parallel lines having the minimum distance therebetween is selected, and the distance between the one pair of parallel lines is defined as the short-axis diameter of the negative electrode active material 30. With respect to the other pair of parallel lines sandwiching the contour of the negative electrode active material 30 therebetween in the direction orthogonal to the one pair of parallel lines defining the short-axis diameter, the distance between the other pair of parallel lines that is the maximum among the respective distances between the pairs of parallel lines is defined as the long-axis diameter of the negative electrode active material 30. It can be said that the closer to 1 the aspect ratio is, the higher the sphericity of the negative electrode active material 30 is. The method for calculating the average aspect ratio of the negative electrode active material 30 in the negative electrode active material layer 11 will be described later.

The negative electrode active material 30 in the negative electrode active material layer 11 may have an average orientation angle of 27 degrees or more.

The closer to 0 degrees the orientation angle of the negative electrode active material 30 in the pressure direction is, the higher the tortuosity of the ion conduction path is. That is, the tortuosity of the ion conduction path depends also on the orientation angle of the negative electrode active material 30. In the case where the negative electrode active material 30 in the negative electrode active material layer 11 obtained by pressure molding has an average orientation angle of 27 degrees or more, the tortuosity of the ion conduction path is suppressed and the ion transport resistance of the negative electrode active material layer 11 is accordingly suppressed. Consequently, high capacity and high charge rate performance can be achieved in all-solid-state lithium-ion secondary batteries.

FIG. 4B is an illustrative diagram showing the method for calculating the orientation angle of the negative electrode active material 30. The arrows in FIG. 4B indicate the pressure directions. As shown in FIG. 4B, the orientation angle of the negative electrode active material 30 is the angle formed between the line segment corresponding to the long-axis diameter of the negative electrode active material 30 in the negative electrode active material layer 11 obtained by pressure molding and the plane perpendicular to the pressure direction (thickness direction of the negative electrode active material layer 11). The method for calculating the average orientation angle of the negative electrode active material 30 in the negative electrode active material layer 11 will be described later.

The negative electrode active material 30 may have an average elastic modulus of 370 MPa or less, or 59 MPa or more and 370 MPa or less. According to the above configuration, it is possible to avoid the generation of microcracks in the negative electrode active material layer 11 due to spring back. The method for calculating the average elastic modulus of the negative electrode active material 30 will be described later.

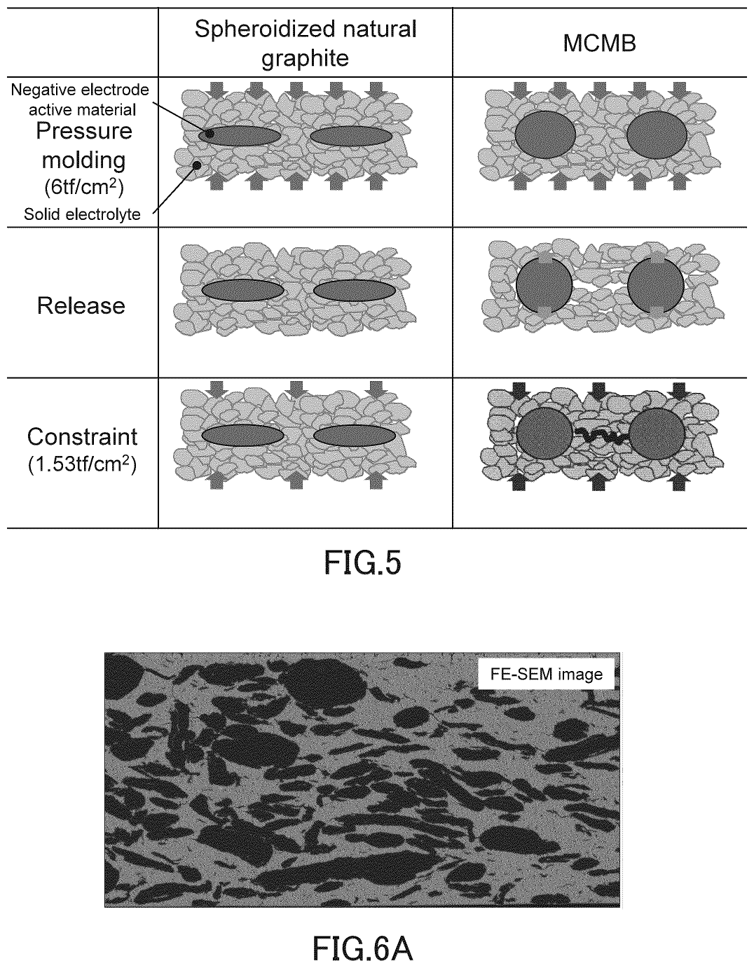

FIG. 5 is an illustrative diagram showing the mechanism of the occurrence of spring back of the negative electrode active material layer. The table in FIG. 5 shows the procedure for producing the negative electrode active material layer in order from the top. First, the negative electrode mixture is pressure-molded at the pressure of 6 tf/cm², the pressure of 6 tf/cm² is released once, and then the negative electrode mixture is constrained at the pressure of 1.53 tf/cm² with a constraining jig. The arrows in the table in FIG. 5 indicate the pressure directions. In the table in FIG. 5, spheroidized natural graphite is shown as an example of a negative electrode active material having low mechanical properties. Mesocarbon microbead (MCMB) is shown as an example of a negative electrode active material having higher mechanical properties than spheroidized natural graphite. In all-solid-state lithium-ion secondary batteries, in order to achieve high density of the negative electrode active material layer, it is important to reduce the voids between the particles of the solid electrolyte by pressure molding at a high pressure. However, as in the MCMB shown in FIG. 5, in the case where the negative electrode active material is too high in mechanical properties, such as particle hardness, the negative electrode active material layer is subjected to the generation of cracks due to spring back at the time of the pressure release, causing the occurrence of path breakage in the ion conduction path. Such path breakage is difficult to repair even by subsequently applying a pressure by constraint with a constraining jig. Note that FIG. 5 is not intended to show that spring back always occurs in the case where the negative electrode active material is MCMB.

On the other hand, according to the negative electrode 12 of the present embodiment, the negative electrode active material 30 has an average elastic modulus of as low as 370 MPa or less. This makes it possible to avoid the generation of cracks in the negative electrode active material layer due to spring back at the time of the pressure release and thus the occurrence of path breakage in the ion conduction path.

The negative electrode active material 30 may have a specific surface area of less than 3.5 m²/g. In all-solid-state lithium-ion secondary batteries during the charge operation, electrons are usually imparted to the negative electrode active material 30 by a reduction reaction. In the case where the electrons are imparted not to lithium ions but to the solid electrolyte 20, the solid electrolyte 20 causes a reductive decomposition reaction, decreasing the charge efficiency of all-solid-state lithium-ion secondary batteries. In the case where the negative electrode active material 30 has a specific surface area of less than 3.5 m²/g, it is possible to suppress the reductive decomposition reaction of the solid electrolyte 20 in the negative electrode active material layer 11. The negative electrode active material 30 may have a specific surface area of 2.5 m²/g or less. The lower limit for specific surface area of the negative electrode active material 30 is not particularly limited, and is, for example, 1.5 m²/g. The method for measuring the specific surface area of the negative electrode active material 30 will be described later.

The negative electrode active material 30 may have a median diameter of 5 μm or more and 20 μm or less. The “median diameter” means the particle diameter at a cumulative volume equal to 50% in the volumetric particle size distribution. The volumetric particle size distribution is measured, for example, with a laser diffraction analyzer. In the case where the negative electrode active material 30 has a median diameter within such a range, it is possible to sufficiently reduce the thickness of the negative electrode active material layer 11.

Examples of the material of the negative electrode active material 30 include a metal, a metalloid, an oxide, a nitride, and a carbon. Examples of the metal or the metalloid include lithium, silicon, amorphous silicon, aluminum, silver, tin, antimony, and an alloy thereof. Examples of the oxide include Li₄Ti₆O₁₂, Li₂SrTi₆O₁₄, TiO₂, Nb₂O₅, SnO₂, Ta₂O₅, WO₂, WO₃, Fe₂O₃, CoO, MoO₂, SiO, SnBPO₆, and a mixture thereof. Examples of the nitride include LiCoN, Li₃FeN₂, Li₇MnN₄, and a mixture thereof. Examples of the carbon include spheroidized natural graphite obtained by folding natural flake graphite into a spherical shape for spheroidizing with a hybridization device, MCMB having high sphericity, artificial graphite obtained by using coal coke or petroleum coke as the raw material, hard carbon, soft carbon, a carbon nanotube, and a mixture thereof. As the negative electrode active material 30, these negative electrode active materials can be used alone or in combination of two or more thereof.

The negative electrode active material 30 may include a graphite, such as spheroidized natural graphite or artificial graphite. Graphites, such as spheroidized natural graphite and artificial graphite, are easily controlled in terms of mechanical properties, such as shape or hardness. According to the above configuration, it is possible to easily control the tortuosity of the ion conduction path in the negative electrode active material layer 11. The negative electrode active material 30 may be a graphite.

In the case where the negative electrode active material 30 is a graphite, the graphite may be spheroidized natural graphite, MCMB, or a mixture thereof. The MCMB may be crushed MCMB obtained by crushing MCMB.

### (Solid Electrolyte 20)

As the solid electrolyte 20, a solid inorganic electrolyte, a solid polymer electrolyte, or a mixture thereof can be used. The solid inorganic electrolyte includes a solid sulfide electrolyte and a solid oxide electrolyte.

The solid electrolyte 20 may include a solid sulfide electrolyte. According to the above configuration, it is possible to achieve an all-solid-state lithium-ion secondary battery with enhanced charge and discharge characteristics.

The solid sulfide electrolyte, which may be included in the solid electrolyte 20, may include a Li₂S—P₂S₆-based glass-ceramic electrolyte. According to the above configuration, it is possible to achieve an all-solid-state lithium-ion secondary battery with further enhanced charge and discharge characteristics. The Li₂S—P₂S₆-based glass-ceramic electrolyte is a solid sulfide electrolyte in the form of glass-ceramics. Examples of the Li₂S—P₂S₅-based glass-ceramic electrolyte include Li₂S—P₂S₅, Li₂S—P₂S₅—LiI, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—GeS, Li₂S—P₂S₅—ZnS, Li₂S—P₂S₅—GaS, Li₂S—GeS₂, Li₂S—SiS₂—Li₃PO₄, Li₂S—SiS₂—LiPO, Li₂S—SiS₂—LiSiO, Li₂S—SiS₂—LiGeO, Li₂S—SiS₂—LiBO, Li₂S—SiS₂—LiAlO, Li₂S—SiS₂—LiGaO, Li₂S—SiS₂—LiInO, Li₄GeS₄—Li₃PS₃, Li₄SiS₄—Li₃PS₄, and Li₃PS₄—Li₂S.

The solid sulfide electrolyte, which may be included in the solid electrolyte 20, may include a solid argyrodite-type sulfide electrolyte. According to the above configuration, it is possible to achieve an all-solid-state lithium-ion secondary battery with further enhanced charge and discharge characteristics. The solid argyrodite-type sulfide electrolyte is a solid sulfide electrolyte having an argyrodite-type crystal phase with high ion conductivity. An example of the solid argyrodite-type sulfide electrolyte is Li₆PS₅Cl.

The solid electrolyte 20 may include only the solid sulfide electrolyte. In other words, the solid electrolyte 20 may consist substantially of the solid sulfide electrolyte. “Including only a solid sulfide electrolyte” means that materials other than the solid sulfide electrolyte are not intentionally added except for inevitable impurities. For example, raw materials of the solid sulfide electrolyte, by-products generated in the production of the solid sulfide electrolyte, and the like are included in the inevitable impurities.

Examples of the solid oxide electrolyte, which may be included in the solid electrolyte 20, include LiPON, LiAlTi(PO₄)₃, LiAlGeTi(PO₄)₃, LiLaTiO, LiLaZrO, Li₃PO₄, Li₂SiO₂, Li₃SiO₄, Li₃VO₄, Li₄SiO₄—Zn₂SiO₄, Li₄GeO₄—Li₂GeZnO₄, Li₂GeZnO₄—Zn₂GeO₄, and Li₄GeO₄—Li₃VO₄.

Examples of the solid polymer electrolyte, which may be included in the solid electrolyte 20, include a fluororesin, polyethylene oxide, polyacrylonitrile, polyacrylate, a derivative thereof, and a copolymer thereof.

The shape of the solid electrolyte 20 is not particularly limited, and may be acicular, spherical, ellipsoidal, flaky, or the like. The shape of the solid electrolyte 20 may be particulate.

In the case where the shape of the solid electrolyte 20 is particulate (e.g., spherical), the solid electrolyte 20 may have a smaller median diameter than the negative electrode active material 30 has. In this case, the negative electrode active material 30 and the solid electrolyte 20 can form a more favorable dispersion state in the negative electrode active material layer 11.

The median diameter of the solid electrolyte 20 may be set so as to correspond to the median diameter of the negative electrode active material 30. In the case where the negative electrode active material 30 has a median diameter of 5 μm or more and 20 μm or less, the solid electrolyte 20 may have a median diameter of 0.5 μm or more and 2 μm or less. According to the above configuration, it is possible to lower the porosity of the negative electrode active material layer 11.

Next, the method for manufacturing the all-solid-state lithium-ion secondary battery negative electrode 12 will be described. The method for manufacturing the all-solid-state lithium-ion secondary battery negative electrode 12 includes: mixing the negative electrode active material 30 and the solid electrolyte 20 to prepare a negative electrode mixture; and pressure-molding the negative electrode mixture to obtain the negative electrode active material layer 11. The pressure-molding the negative electrode mixture is performed so that the negative electrode active material 30 in the negative electrode active material layer 11 has an average aspect ratio of more than 0.5. The negative electrode active material 30 used is a negative electrode active material having an average elastic modulus of 370 MPa or less.

### <Method for Calculating Porosity of Negative Electrode Active Material Layer 11>

The porosity of the negative electrode active material layer 11 of Embodiment 1 is calculated, for example, by the following method.

First, the pore volume distribution of the negative electrode active material layer 11 is measured with a mercury porosimeter. The porosimeter to be used is “AutoPore III9410” manufactured by Shimadzu Corporation. From the obtained pore volume distribution, the distribution of pores having a pore size of 15 μm or less is extracted (excluding the distribution of pores having a pore size of more than 15 μm) to determine its cumulative pore volume (Vp). Note that the pores having a pore size of more than 15 μm are derived, for example, from the unevenness of the surface of the negative electrode active material layer 11, and accordingly are not included in the cumulative pore volume. The cumulative pore volume Vp thus obtained is divided by the apparent volume (Va) of the active material layer and the following equation (1) is used, so that the porosity of the negative electrode active material layer 11 can be determined. The apparent volume Va is calculated from the projected area (S) of the negative electrode active material layer 11 and the thickness (T) of the negative electrode active material layer 11 (Va=ST). The thickness (T) of the negative electrode active material layer 11 is measured with a contact thickness meter.

Porosity (%)=(Vp/Va)×100 (1)

### <Method for Calculating Average Aspect Ratio of Negative Electrode Active Material 30 in Negative Electrode Active Material Layer 11>

The average aspect ratio of the negative electrode active material 30 in the negative electrode active material layer 11 of Embodiment 1 is calculated, for example, by the following method.

First, the negative electrode active material layer 11 obtained by pressure molding is subjected to a cross-section process by Cross Section Polisher (CP) (registered trademark) method, and the polished surface is observed with a field emission scanning electron microscope (FE-SEM). The FE-SEM image captured is binarized with image processing software to distinct between the negative electrode active material 30 and the solid electrolyte 20, so that the contour of the negative electrode active material is extracted.

Next, from the binary image thus obtained, the aspect ratio of each of the negative electrode active materials 30 is obtained. As shown in FIG. 4A, the aspect ratio of the negative electrode active material 30 is determined as the ratio of the short-axis diameter to the long-axis diameter of the negative electrode active material 30. In the present embodiment, one binary image includes 100 to 200 negative electrode active materials 30 from which the contour has been extracted. The average aspect ratio is calculated from the aspect ratios of these 100 to 200 negative electrode active materials Note that while one FE-SEM image and a binary image obtained by binarizing the one FE-SEM image are two-dimensional information, repeating the cross-section process by the CP method and the cross-sectional observation also enables three-dimensional information to be restored.

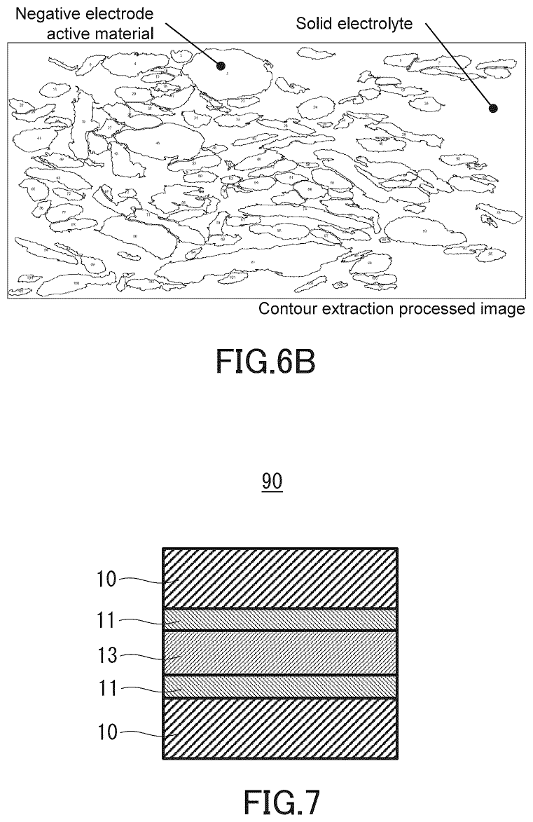

FIG. 6A is an example of the FE-SEM image of the negative electrode active material layer. The FE-SEM image of FIG. 6A shows one cross section of the negative electrode active material layer, and includes, as the negative electrode active material, natural flake graphite of Comparative Example 1 which will be described later. FIG. 6B is a binary image obtained by binarizing the FE-SEM image shown in FIG. 6A. The binary image shown in FIG. 6B includes 107 negative electrode active materials.

### <Method for Calculating Average Orientation Angle of Negative Electrode Active Material 30 in Negative Electrode Active Material Layer 11>

From a binary image, such as illustrated in FIG. 6B, obtained by binarizing an FE-SEM image, the orientation angle of the negative electrode active material 30 can also be obtained in addition to the aspect ratio of the negative electrode active material 30. As shown in FIG. 4B, the angle formed between a line segment corresponding to the long-axis diameter of the negative electrode active material 30 and a plane perpendicular to the pressure direction is determined as the orientation angle of the negative electrode active material 30. In the present embodiment, as in the case of the average aspect ratio, the average orientation angle is calculated from the orientation angles of 100 to 200 negative electrode active materials 30 included in the binary image obtained by binarizing the FE-SEM image.

### <Method for Calculating Average Elastic Modulus of Negative Electrode Active Material 30>

The average elastic modulus of the negative electrode active material 30 of Embodiment 1 is determined based on “Measurement Method for Fracture Strength and Deformation Strength of Fine Particles” of Japanese Industrial Standards JIS Z 8844: 2019, which is utilized in the fields of food processing and medicine. The average elastic modulus of the negative electrode active material 30 is calculated based on the 10% deformation strength of the negative electrode active material 30 as the fine particles measured with micro compression tester “MCT-510” manufactured by Shimadzu Corporation.

First, the median diameter of the negative electrode active material 30 is determined with a laser diffraction scattering particle size analyzer. Next, seven negative electrode active materials 30 each having a size close to the determined median diameter are selected. The seven selected negative electrode active materials 30 are subjected to a micro compression test with a conical plane indenter (Φ 50 μm), where the compressive force is set to 49 mN, the loading rate is set to 1.0141 mN/sec, and the load holding period is set to 5 seconds. From the five negative electrode active materials 30 excluding those having the maximum value and the minimum value, the average value of the 10% deformation strength is calculated. Since the deformation rate is 10%, the elastic modulus corresponding to the spring constant of a single particle of the negative electrode active material 30 is calculated as 10 times the 10% deformation strength.

In the present embodiment, the average elastic modulus is calculated by measuring the 10% deformation strength of the raw particles of the negative electrode active material 30. Alternatively, the average elastic modulus of the negative electrode active material 30 can be calculated also by, for example, measuring the 10% deformation strength of the negative electrode active material 30 extracted from the negative electrode active material layer 11 obtained by pressure molding. Within the deformation rate of 10% to 30%, about half of the negative electrode active materials 30 included in the negative electrode active material layer 11 is not subjected to collapse caused by pressure molding irrespective of whether it has the secondary structure or the primary structure. When the pressure of the pressure molding is released, the negative electrode active materials 30, which have not been subjected to the collapse, become restored to return to their original shapes and remain unchanged in terms of mechanical properties as well. Consequently, no significant difference can be regarded as lying between the average elastic modulus calculated from the negative electrode active materials 30 extracted from the negative electrode active material layer 11 obtained by pressure molding and the average elastic modulus of the raw particles of the negative electrode active material 30.

Note that WO 2014/016907 A1 focuses on the hardness of the graphite as the negative electrode active material on the submicron scale, for example, on the scale of the edge planes and the basal planes. Accordingly, in WO 2014/016907 A1, the hardness of graphite is measured by the nanoindentation method. In the present disclosure, the focus is not on the hardness of the negative electrode active material 30 on the submicron scale but on the mechanical properties of the negative electrode active material 30 as a single particle, and accordingly the nanoindentation method is not used.

### <Method for Measuring Specific Surface Area of Negative Electrode Active Material 30>

The specific surface area of the negative electrode active material 30 of Embodiment 1 can be measured, for example, by mercury porosimetry. The specific surface area of the negative electrode active material 30 can be determined also by conducting a conversion by the Brunauer-Emmett-Teller (BET) method on the data of an adsorption isotherm obtained through gas adsorption using argon gas.

### <Method for Calculating Average Circularity and Average Aspect Ratio of Negative Electrode Active Material 30>

The circularity and aspect ratio of the raw particles of the negative electrode active material 30 can be obtained by particle shape analysis with, for example, the particle shape analyzer manufactured by Malvern Panalytical Ltd. The fine particles of the negative electrode active material 30 having an equivalent circle diameter of less than 0.5 μm have the particle diameter less than the lower limit particle diameter at which the shape is recognizable, and are accordingly excluded from the analysis data. The circularity and the aspect ratio are measured for 20000 to 30000 raw particles of the negative electrode active material 30 having an area equivalent diameter of 0.5 μm or more. The average value of the measured circularity and the average value of the measured aspect ratio are respectively taken as the average circularity and the average aspect ratio of the raw particles of the negative electrode active material 30.

### Embodiment 2

Embodiment 2 will be described below. The description overlapping with that of Embodiment 1 will be omitted as appropriate.

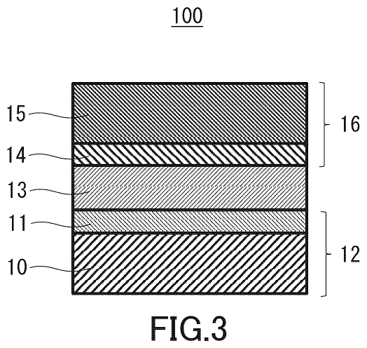

FIG. 3 is a cross-sectional view schematically showing the configuration of an all-solid-state lithium-ion secondary battery 100 of Embodiment 2.

The all-solid-state lithium-ion secondary battery 100 can be configured as batteries having various shapes, such as a coin type, a cylindrical type, a prismatic type, a sheet type, a button type, a flat type, or a stacked type.

The all-solid-state lithium-ion secondary battery 100 of Embodiment 2 includes a positive electrode 16, a solid electrolyte layer 13, and a negative electrode 12.

The solid electrolyte layer 13 is disposed between the positive electrode 16 and the negative electrode 12.

The negative electrode 12 is the all-solid-state lithium-ion secondary battery negative electrode 12 of Embodiment 1. According to the above configuration, it is possible to achieve high capacity and high charge rate performance in the all-solid-state lithium-ion secondary battery 100.

### [Positive Electrode 16]

The positive electrode 16 of Embodiment 2 includes a positive electrode current collector 15 and a positive electrode active material layer 14. The positive electrode active material layer 14 includes a solid electrolyte and a positive electrode active material.

### [Positive Electrode Current Collector 15]

The positive electrode current collector 15 is formed of an electronic conductor. As the material of the positive electrode current collector 15, those described for the negative electrode current collector 10 of Embodiment 1 can be used as appropriate.

### [Positive Electrode Active Material Layer 14]

The positive electrode active material layer 14 is a layer in which the positive electrode active material and the solid electrolyte are mixed in a predetermined volume composition ratio and dispersed.

The volume composition ratio of the positive electrode active material to the positive electrode active material layer 14 may be 60% or more and 90% or less.

The positive electrode active material layer 14 may include a conductive additive, a binder, and the like as necessary. As the conductive additive and the binder, those described for the negative electrode active material layer 11 of Embodiment 1 can be used as appropriate.

The positive electrode active material layer 14 may have a thickness of 5 μm or more and 200 μm or less for the same reason as in the case of the negative electrode active material layer 11.

### (Positive Electrode Active Material)

The positive electrode active material is a material having properties of occluding and releasing lithium ions.

Examples of the material of the positive electrode active material include a lithium-including transition metal oxide, a vanadium oxide, a chromium oxide, and a lithium-including transition metal sulfide. Examples of the lithium-including transition metal oxide include LiCoO₂, LiNiO₂, LiMnO₂, LiMn₂O₄, LiNiCoMnO₂, LiNiCoO₂, LiCoMnO₂, LiNiMnO₂, LiNiCoMnO₄, LiMnNiO₄, LiMnCoO₄, LiNiCoAlO₂, LiNiPO₄, LiCoPO₄, LiMnPO₄, LiFePO₄, Li₂NiSiO₄, Li₂CoSiO₄, Li₂MnSiO₄, Li₂FeSiO₄, LiNiBO₃, LiCoBO₃, LiMnBO₃, and LiFeBO₃. Examples of the lithium-including transition metal sulfide include LiTiS₂, Li₂TiS₃, and Li₃NbS₄. As the positive electrode active material, these positive electrode active materials can be used alone or in combination of two or more thereof.

The positive electrode active material layer 14 may include, as the positive electrode active material, Li(Ni,Co,Mn)O₂. In the present disclosure, when an element in a formula is expressed by “(Ni,Co,Mn)” or the like, this expression indicates at least one element selected from the group of elements in parentheses. That is, “(Ni,Co,Mn)” is synonymous with “at least one selected from the group consisting of Ni, Co, and Mn”. The same applies to other elements. The positive electrode active material layer 14 may include, as the positive electrode active material, Li(NiCoMn)O₂ (hereinafter referred to as NCM). That is, the positive electrode active material layer 14 may include, as the positive electrode active material, lithium nickel cobalt manganese oxide. The positive electrode active material layer 14 may include, as the positive electrode active material, NCM in which Ni:Co:Mn=5:2:3. NCM in which Ni:Co:Mn=5:2:3 is hereinafter referred to as NCM523.

The positive electrode active material may have a median diameter of 1 μm or more and 10 μm or less. In the case where the positive electrode active material is in the form of secondary particles obtained by granulating primary particles having the size of about 0.1 μm to 1 μm through sintering and aggregation, the upper limit for median diameter of the positive electrode active material may be 10 μm.

### (Solid Electrolyte)

As the solid electrolyte included in the positive electrode active material layer 14, a solid inorganic electrolyte or a solid polymer electrolyte can be used. As the solid inorganic electrolyte and the solid polymer electrolyte, those described for the negative electrode active material layer 11 of Embodiment 1 can be used as appropriate.

The positive electrode active material layer 14 may include, as the solid electrolyte, a solid sulfide electrolyte. As the solid sulfide electrolyte, those described for the negative electrode active material layer 11 of Embodiment 1 can be used as appropriate.

The shape of the solid electrolyte included in the positive electrode active material layer 14 is not particularly limited, and may be acicular, spherical, ellipsoidal, flaky, or the like. The shape of the solid electrolyte included in the positive electrode active material layer 14 may be particulate.

In the case where the shape of the solid electrolyte included in the positive electrode active material layer 14 is particulate (e.g., spherical), the solid electrolyte included in the positive electrode active material layer 14 may have a smaller median diameter than the positive electrode active material has. In this case, the positive electrode active material and the solid electrolyte can form a more favorable dispersion state in the positive electrode active material layer 14.

The median diameter of the solid electrolyte included in the positive electrode active material layer 14 may be set so as to correspond to the median diameter of the positive electrode active material. In the case where the positive electrode active material has a median diameter of 1 μm or more and 10 μm or less, the solid electrolyte included in the positive electrode active material layer 14 may have a median diameter of 0.1 μm or more and 1 μm or less. According to the above configuration, it is possible to lower the porosity of the positive electrode active material layer 14.

### [Solid Electrolyte Layer 13]

The solid electrolyte layer 13 is a layer including a solid electrolyte. As the solid electrolyte included in the solid electrolyte layer 13, a solid inorganic electrolyte or a solid polymer electrolyte can be used. As the solid inorganic electrolyte and the solid polymer electrolyte, those described for the negative electrode active material layer 11 of Embodiment 1 can be used as appropriate.

The shape of the solid electrolyte included in the solid electrolyte layer 13 is not particularly limited, and may be acicular, spherical, ellipsoidal, flaky, or the like. The shape of the solid electrolyte included in the solid electrolyte layer 13 may be particulate.

In the case where the shape of the solid electrolyte included in the solid electrolyte layer 13 is particulate (e.g., spherical), the solid electrolyte may have a median diameter of 0.1 μm or more and 10 μm or less. In the case where the particles of the solid electrolyte have a median diameter within such a range, the solid electrolyte layer 13 is less prone to the generation of pinholes and the solid electrolyte layer 13 having a uniform thickness is easily formed.

The solid electrolyte layer 13 may include a conductive additive, a binder, and the like, as necessary. As the conductive additive and the binder, those described for the negative electrode active material layer 11 of Embodiment 1 can be used as appropriate.

The solid electrolyte layer 13 may have a thickness of 15 μm or more and 60 μm or less. In this case, the number of particles of the solid electrolyte included in the thickness direction of the solid electrolyte layer 13 may be three or more.

### EXAMPLES

The present disclosure will be described in detail below with use of comparative examples and examples.

### [Evaluation of Raw Particles of Negative Electrode Active Material]

For the raw particles of the negative electrode active material in each of Comparative Examples 1 to 4 and Examples 1 to 4, the median diameter, the specific surface area, the average circularity, the average aspect ratio, and the average elastic modulus were determined by the above calculation method and measurement method.

### Comparative Example 1

The negative electrode active material used was spheroidized natural graphite obtained by folding natural flake graphite into a spherical shape for spheroidizing with a hybridization device. This spheroidized natural graphite is referred to as spheroidized natural graphite A. The spheroidized natural graphite A had an average circularity of and an average aspect ratio of 0.655. The spheroidized natural graphite A had a median diameter of 10.6 μm. The spheroidized natural graphite A had an average 10% deformation strength of 5.55 MPa. That is, the spheroidized natural graphite A had an average elastic modulus of 55.5 MPa. In addition, the negative electrode active material layer including the spheroidized natural graphite A as the negative electrode active material had a porosity of 6.3% calculated by the above equation (1).

For the measurement of the porosity of the negative electrode active material layer of Comparative Example 1, a compacted pellet of a negative electrode mixture including a negative electrode active material and a solid sulfide electrolyte was used. The compacted pellet was produced by the following method. First, into a hollow Macor with a hole of 1 cm², 11.4 mg of a powdered negative electrode mixture having a volume composition ratio of the negative electrode active material and the solid sulfide electrolyte of 50%:50% was put, and pressed at a pressure of 1 tf/cm² for 1 minute. Next, the mixture was pressed at a pressure of 6 tf/cm² for 1 minute. Thus, the compacted pellet of Comparative Example 1 was obtained. The solid sulfide electrolyte used was a solid argyrodite-type sulfide electrolyte. The solid argyrodite-type sulfide electrolyte had an average particle diameter (median diameter) of 0.6 μm.

### Comparative Example 2

The negative electrode active material used was spheroidized natural graphite obtained by spheroidizing natural flake graphite that is different in raw ore from the spheroidized natural graphite A of Comparative Example 1. This spheroidized natural graphite is referred to as spheroidized natural graphite B. The spheroidized natural graphite B had an average circularity of 0.918 and an average aspect ratio of 0.691. The spheroidized natural graphite B had a median diameter of 18.4 μm. The spheroidized natural graphite B had an average 10% deformation strength of 3.05 MPa. That is, the spheroidized natural graphite B had an average elastic modulus of 30.5 MPa.

### Comparative Example 3

The negative electrode active material used was MCMB. This MCMB is referred to as uncrushed MCMB A. MCMB is in the form of primary particles in which a graphene layer is grown into the shape of concentric spheres, and is different from spheroidized natural graphite in the form of secondary particles obtained by folding natural flake graphite in the form of primary particles into a spherical shape for spheroidizing. The uncrushed MCMB A had an average circularity of 0.960 and an average aspect ratio of 0.836. The uncrushed MCMB A had a median diameter of 11.6 μm. The uncrushed MCMB A had an average 10% deformation strength of 37.9 MPa. That is, the uncrushed MCMB A had an average elastic modulus of 379 MPa.

### Comparative Example 4

The negative electrode active material used was MCMB obtained by enhancing the particle hardness of the uncrushed MCMB A of Comparative Example 3 with no great change in particle shape and particle diameter. This MCMB is referred to as uncrushed MCMB B. The uncrushed MCMB B had a median diameter of 11.0 μm, which is about the same as that of Comparative Example 3. On the other hand, the uncrushed MCMB B had an average 10% deformation strength of 88.9 MPa. That is, the uncrushed MCMB B had an average elastic modulus of 889 MPa. In addition, the negative electrode active material layer including the uncrushed MCMB B as the negative electrode active material had a porosity of 9.1% calculated by the above equation (1). The compacted pellet of Comparative Example 4 used for measuring the porosity of the negative electrode active material layer was produced by the same method as that of the compacted pellet of Comparative Example 1 except for the replacement of the spheroidized natural graphite A with the uncrushed MCMB B.

### Example 1

The negative electrode active material used was spheroidized natural graphite with enhanced sphericity obtained by subjecting natural flake graphite that is the same in raw ore as the spheroidized natural graphite A of Comparative Example 1 to further granulation through spheroidizing as compared with the spheroidized natural graphite A. This spheroidized natural graphite is referred to as spheroidized natural graphite C. The spheroidized natural graphite C had an average circularity of 0.932 and an average aspect ratio of 0.703. The spheroidized natural graphite C had a median diameter of 15.8 μm. The spheroidized natural graphite C had an average 10% deformation strength of 7.37 MPa. That is, the spheroidized natural graphite C had an average elastic modulus of 73.7 MPa. In addition, the negative electrode active material layer including the spheroidized natural graphite C as the negative electrode active material had a porosity of 7.4% calculated by the above equation (1). The compacted pellet of Example 1 used for measuring the porosity of the negative electrode active material layer was produced by the same method as that of the compacted pellet of Comparative Example 1 except for the replacement of the spheroidized natural graphite A with the spheroidized natural graphite C.

### Example 2

The negative electrode active material used was spheroidized natural graphite with enhanced sphericity as compared with the spheroidized natural graphite A, obtained by spheroidizing natural flake graphite that is different in raw ore from the spheroidized natural graphite A of Comparative Example 1. This spheroidized natural graphite is referred to as spheroidized natural graphite D. The spheroidized natural graphite D had an average circularity of 0.935 and an average aspect ratio of 0.686. The spheroidized natural graphite D had a median diameter of 11.4 μm. The spheroidized natural graphite D had an average 10% deformation strength of 5.96 MPa. That is, the spheroidized natural graphite D had an average elastic modulus of 59.6 MPa.

### Example 3

The negative electrode active material used was MCMB obtained by finely crushing MCMB obtained through further growing and granulating of the uncrushed MCMB A of Comparative Example 3. This crushed MCMB is referred to as crushed MCMB C. The crushed MCMB C had an average circularity of 0.903 and an average aspect ratio of 0.702. The crushed MCMB C had a median diameter of 12.3 μm. The crushed MCMB C had an average 10% deformation strength of 17.9 MPa. That is, the crushed MCMB C had an average elastic modulus of 179 MPa. In addition, the negative electrode active material layer including the crushed MCMB C as the negative electrode active material had a porosity of 7.2% calculated by the above equation (1). The compacted pellet of Example 3 used for measuring the porosity of the negative electrode active material layer was produced by the same method as that of the compacted pellet of Comparative Example 1 except for the replacement the spheroidized natural graphite A with the crushed MCMB C.

### Example 4

The negative electrode active material used was MCMB crushed more finely than the crushed MCMB C of Example 3. This MCMB crushed more finely is referred to as crushed MCMB D. The crushed MCMB D had an average circularity of 0.924 and an average aspect ratio of 0.741. The crushed MCMB D had a median diameter of 8.1 μm. The crushed MCMB D had an average 10% deformation strength of 36.7 MPa. That is, the crushed MCMB D had an average elastic modulus of 367 MPa.

### [Evaluation of Negative Electrode Active Material Layer and Negative Electrode Active Material in Negative Electrode Active Material Layer]

### <Method for Measuring Ion Transport Resistance of Negative Electrode Active Material Layer>

The ion transport resistance of the negative electrode active material layer is measured, for example, by the following method.

FIG. 7 is a cross-sectional view schematically showing the configuration of an evaluation cell for use in measurement of ion transport resistance. First, an evaluation cell whose both electrodes are negative electrodes, such as shown in FIG. 7, is produced. The evaluation cell is a symmetric cell 90 in which the negative electrode active material layer 11 and the negative electrode current collector 10 are stacked on both sides of the solid electrolyte layer 13. In the symmetric cell 90, the pair of negative electrode active material layers 11, which are disposed on both sides of the solid electrolyte layer 13, are equal in weight per unit area. In the symmetric cell 90, the pair of negative electrode current collectors 10, which are disposed on both sides of the solid electrolyte layer 13, are equal in weight per unit area.

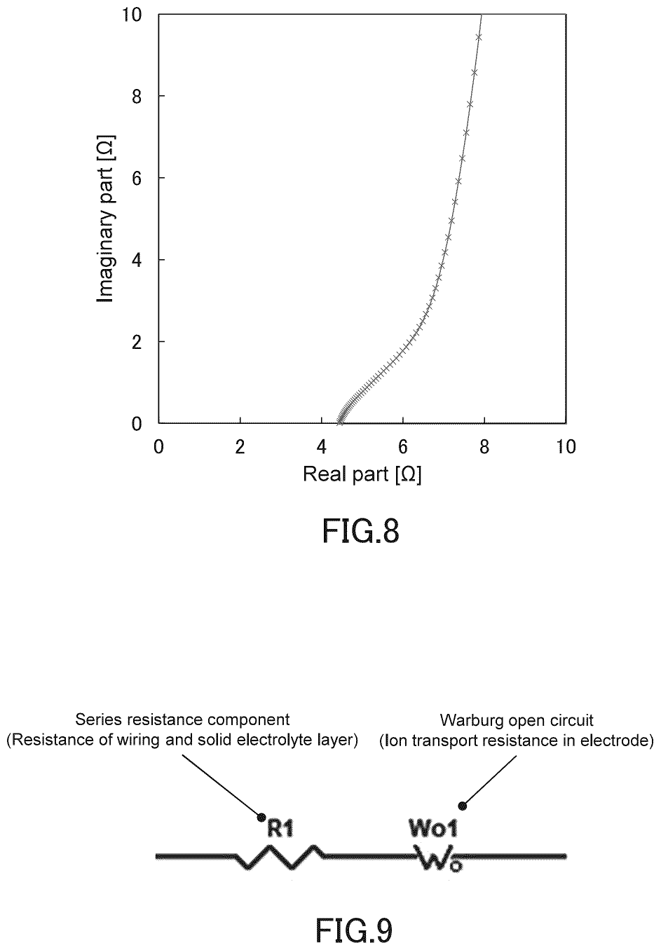

Next, an alternating-current impedance measurement of the symmetric cell 90 is performed with VMP300 manufactured by Bio-Logic SAS, where the voltage amplitude is set to 10 mV and the frequency range is set to 7 MHz to 100 mHz. FIG. 8 is a graph showing the Cole-Cole plot obtained by the impedance measurement of the symmetric cell 90. FIG. 9 is a diagram showing the equivalent circuit of the symmetric cell shown in FIG. 7. By fitting the graph in FIG. 8 with the equivalent circuit shown in FIG. 9, a resistance value Wo-R of the Warburg open circuit is calculated. The calculated resistance value Wo-R indicates the ion transport resistance value of the negative electrode active material layer 11 for two layers. Accordingly, half of the resistance value Wo-R of the Warburg open circuit corresponds to the ion transport resistance of the negative electrode active material layer 11 for one layer.

In accordance with the above measurement method, the ion transport resistance of the negative electrode active material layer including the negative electrode active material was measured for Comparative Examples 1 to 4 and Examples 1 to 4.

First, the symmetric cell 90 was produced for Comparative Examples 1 to 4 and Examples 1 to 4. The solid electrolyte used to be included in the negative electrode active material layer 11 was a solid argyrodite-type sulfide electrolyte. The solid argyrodite-type sulfide electrolyte had an average particle diameter (median diameter) of 0.6 μm. The volume composition ratio of the negative electrode active material and the solid sulfide electrolyte to the total volume of the materials included in the negative electrode active material layer 11 was set to 50%:50%. The weight per unit area of the negative electrode active material layer 11 was set to 11.4 mg.

Here, the method for producing the symmetric cell 90 will be described in detail. First, into a hollow Macor with a hole of 1 cm², 100 mg of a powdered solid sulfide electrolyte was put, and pressed at a pressure of 1 tf/cm² for 1 minute for primary molding of the solid electrolyte layer 13. Next, on the lower side of the solid electrolyte layer 13 obtained by the primary molding, 11.4 mg of a powdered negative electrode mixture having a volume composition ratio of the negative electrode active material and the solid sulfide electrolyte of 50%:50% was put, and pressed at a pressure of 1 tf/cm² for 1 minute for primary molding of the lower negative electrode active material layer 11. Next, on the upper side of the solid electrolyte layer 13, 11.4 mg of the powdered negative electrode mixture was put, and pressed at a pressure of 1 tf/cm² for 1 minute for primary molding of the upper negative electrode active material layer 11. Next, on each of the upper side of the upper negative electrode active material layer 11 and the lower side of the lower negative electrode active material layer 11, the current collector 10 was put, and pressed at a pressure of 6 tf/cm² for 1 minute for main molding. After the main molding ended, the pressure of 6 tf/cm² was released once, and the symmetric cell was constrained at a pressure of 1.53 tf/cm² with a constraining jig.

The produced symmetric cells 90 of Comparative Examples 1 to 4 and Examples 1 to 4 were used to measure the ion transport resistance of the respective negative electrode active material layers 11 by the alternating-current impedance method.

Next, for each of the symmetric cells 90 of Comparative Examples 1 to 4 and Examples 1 to 4, the constraining jig was disassembled to take out the symmetric cell 90 in the shape of a pellet of 1 cm². The pellet-shaped symmetric cells 90 taken out were each subjected to a cross-section process by the CP method to obtain an FE-SEM image. From the image obtained by binarizing the obtained FE-SEM image, the average aspect ratio and average orientation angle of the negative electrode active material in the negative electrode active material layer 11 were determined by the above calculation method for Comparative Examples 1 to 4 and Examples 1 to 4. Note that for Comparative Example 3 in which electrode breakage occurred due to spring back, the aspect ratio and orientation angle of the negative electrode active material were not measurable.

Furthermore, for Comparative Examples 1 to 4 and Examples 1 to 4, the cumulative irreversible capacity of the negative electrode active material layer 11 was measured by the following procedure.

First, for Comparative Examples 1 to 4 and Examples 1 to 4, a half cell for negative electrode evaluation was produced in which a lithium-indium alloy was used as the counter electrode. The volume composition ratio of the negative electrode active material and the solid sulfide electrolyte to the total volume of the materials included in the negative electrode active material layer was set to 50%:50%, which is equal to that in the symmetric cell above. The negative electrode current collector used was a stainless steel foil. Charge and discharge were repeated three times for the produced half-cells of Comparative Examples 1 to 4 and Examples 1 to 4. The sum of the differences between the charge capacity and the discharge capacity for the three times was calculated as the cumulative irreversible capacity.

The results obtained by the above measurement are shown in Table 1.

TABLE 1

| | Raw particles | | | | | | Negative electrode active material layer | | | |
|---|---|---|---|---|---|---|---|---|---|---|
| | Negative | | Specific | | | Average | Ion | | | Cumulative |
| | electrode | Median | surface | | Average | elastic | transport | Average | Average | irreversible |
| | active | diameter | area | Average | aspect | modulus | resistance | aspect | orientation | capacity |
| | material | (μm) | (m²/g) | circularity | ratio | (MPa) | (Ω · cm²) | ratio | angle | (mAh/g) |
| Comparative | Spheroidized | 10.6 | 6.06 | 0.904 | 0.655 | 55.5 | 17.94 | 0.442 | 14.2 | 25.1 |
| Example 1 | natural | | | | | | | | | |
| | graphite A | | | | | | | | | |
| Comparative | Spheroidized | 18.4 | 4.35 | 0.918 | 0.691 | 30.5 | 19.01 | 0.45 | 14.6 | 18.5 |
| Example 2 | natural | | | | | | | | | |
| | graphite B | | | | | | | | | |
| Comparative | Uncrushed | 11.6 | 1.28 | 0.96 | 0.836 | 379 | 24.38 | Not | Not | 13.2 |
| Example 3 | MCMB A | | | | | | | measurable *¹ | measurable *¹ | |
| Comparative | Uncrushed | 11.0 | 0.82 | — | — | 889 | 29.35 | 0.827 | 32.1 | 10.0 |
| Example 4 | MCMB B | | | | | | | | | |
| Example 1 | Spheroidized | 15.8 | 5.29 | 0.932 | 0.703 | 73.7 | 15.34 | 0.527 | 17.2 | 18.3 |
| | natural | | | | | | | | | |
| | graphite C | | | | | | | | | |
| Example 2 | Spheroidized | 11.4 | 5.95 | 0.935 | 0.686 | 59.6 | 15.68 | 0.507 | 15 | 21.4 |
| | natural | | | | | | | | | |
| | graphite D | | | | | | | | | |
| Example 3 | Crushed | 12.3 | 1.73 | 0.903 | 0.702 | 179 | 14.89 | 0.64 | 22.7 | 18.5 |
| | MCMB C | | | | | | | | | |
| Example 4 | Crushed | 8.1 | 1.72 | 0.924 | 0.741 | 367 | 13.95 | 0.671 | 26.8 | 15.4 |
| | MCMB D | | | | | | | | | |

*¹ Not measurable due to occurrence of electrode breakage caused by spring back

Note that the ion transport resistance (4 cm²) can be converted into the resistivity (4 cm). Here, the thickness of each of the negative electrode active material layers of
Comparative Examples 1 to 4 and Examples 1 to 4 is as follows.
Comparative Example 1: 61.0 μm
Comparative Example 2: No data
Comparative Example 3: No data
Comparative Example 4: 62.45 μm
Example 1: 60.70 μm
Example 2: No data
Example 3: 60.70 μm
Example 4: No data

For each of Comparative Examples 1 to 4 and Examples 1 to 4, the resistivity can be calculated by dividing the ion transport resistance described in Table 1 by the thickness of the negative electrode active material layer.

Since spheroidized natural graphite is in the form of secondary particles obtained by folding and spheroidizing natural flake graphite in the form of primary particles, the hardness as a single particle is generally lower than that of the positive electrode active material or the solid electrolyte. In all-solid-state lithium-ion secondary batteries, unlike lithium-ion secondary batteries using an electrolyte solution, the ion conduction path is formed by mixing the negative electrode active material and the solid electrolyte and pressure-molding the resultant mixture at a high pressure. Accordingly, in all-solid-state lithium-ion secondary batteries, in the case where the negative electrode active material in the negative electrode active material layer greatly becomes deformed and oriented by pressure molding, the tortuosity of the ion conduction path is increased, causing an increase in ion transport resistance.

For this reason, to utilize spheroidized natural graphite as the negative electrode active material for all-solid-state lithium-ion secondary batteries, it is important to increase the sphericity and mechanical properties of the raw particles. Specifically, the sphericity of the raw particles is increased by improving the material, shape, and size of natural flake graphite in the form of primary particles or by improving the spheroidizing method therefor.

In Example 1, the natural flake graphite used was the same in raw ore as that of Comparative Example 1, but was one subjected to further granulation through spheroidizing as compared with Comparative Example 1 thus to have enhanced sphericity and mechanical properties of the raw particles. In fact, the negative electrode active material layer obtained by pressure molding of Example 1 had the improved average aspect ratio and average orientation angle as compared with those of the negative electrode active material layer obtained by pressure molding of Comparative Example 1. Consequently, the negative electrode active material layer obtained by pressure molding of Example 1 was able to have an ion transport resistance of 17.94 Ω·cm², which is lower than 15.34 Ω·cm² in Comparative Example 1.

In Comparative Example 2, the natural flake graphite that is different in raw ore from that of Comparative Example 1 was used. In Example 2, the natural flake graphite that is different in raw ore from that of Example 1 was used. In Comparative Example 2 and Example 2, the sphericity was further enhanced as compared with that of the spheroidized natural graphite A of Comparative Example 1. However, the raw particles of Comparative Example 2 had a lower average elastic modulus and worse mechanical properties than those of Comparative Example 1. Accordingly, in Example 2, the average elastic modulus of the raw particles was increased by decreasing the median diameter without significantly changing the sphericity from that of Comparative Example 2. The raw particles of Example 2 had the improved average circularity, average aspect ratio, and average elastic modulus as compared with those of the raw particles of Comparative Example 1. In addition, the raw particles of Example 2 had the enhanced average elastic modulus as compared with that of the raw particles of Comparative Example 2. In fact, the negative electrode active material layer obtained by pressure molding of Example 2 had the improved average aspect ratio and average orientation angle as compared with those of the negative electrode active material layer obtained by pressure molding of Comparative Example 2. Consequently, the negative electrode active material layer obtained by pressure molding of Example 2 was able to have an ion transport resistance of 15.68 Ω·cm², which is lower than 19.01 Ω·cm² in Comparative Example 2.

In each of Comparative Examples 3 and 4, the different uncrushed MCMB was used. MCMB is in the form of primary particles and accordingly is higher in mechanical properties as the particles than spheroidized natural graphite in the form of secondary particles. In addition, MCMB is high in sphericity as well, as evidenced by its average circularity of more than 0.950. Accordingly, in Comparative Example 4, the negative electrode active material layer had the significantly improved average aspect ratio and average orientation angle as compared with those of Comparative Examples 1 and 2 in which the spheroidized natural graphite was used. On the other hand, in Comparative Examples 2 and 4, no improvement was observed in ion transport resistance of the negative electrode active material layer. This is because, as shown in FIG. 5, microcracks were generated in the negative electrode active material layer due to spring back at the time of the pressure release between the pressure molding at 6 tf/cm² and the constraint at 1.53 tf/cm² with the constraining jig.

### [Verification Experiment of Spring Back Influence]

Next, an experiment was performed to verify the influence of spring back, which occurs at the time of the pressure release after the pressure molding of the negative electrode active material layer.

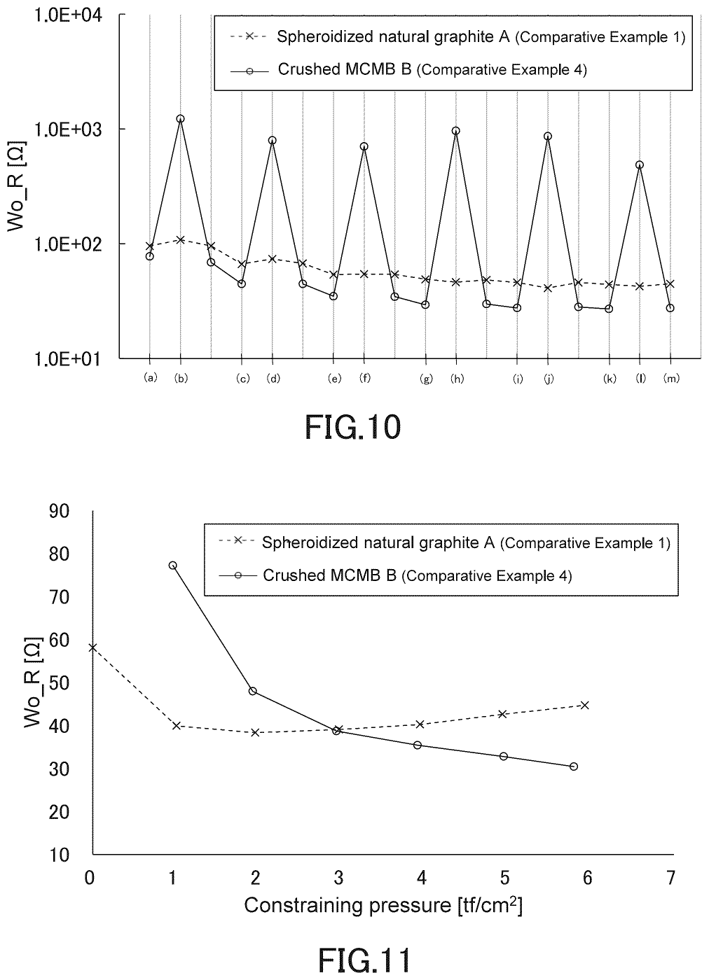

For Comparative Examples 1 and 4, a stack in a state before main molding by pressing at 6 tf/cm² for 1 minute was prepared by the above procedure for producing the symmetric cell 90. The pressure for pressing the stack was changed in the order of the following states (a) to (m) with a hydraulic press machine. In each of the following states (a) to (m), the resistance value Wo-R of the Warburg open circuit was calculated by the above method for measuring the ion transport resistance of the negative electrode active material layer. The results are shown in FIG. 10.
(a) State in which a pressure of 1 tf/cm² is applied
(b) Released state
(c) State in which a pressure of 2 tf/cm² is applied
(d) Released state
(e) State in which a pressure of 3 tf/cm² is applied
(f) Released state
(g) State in which a pressure of 4 tf/cm² is applied
(h) Released state
(I) State in which a pressure of 5 tf/cm² is applied
(j) Released state
(k) State in which a pressure of 6 tf/cm² is applied
(l) Released state
(m) State in which a pressure of 6 tf/cm² is applied

FIG. 10 is a graph showing the relation between the pressing pressure and the resistance value Wo-R of the Warburg open circuit for the symmetric cells of Comparative Example 1 and Comparative Example 4. The horizontal axis represents the pressing pressure in the order from the above states (a) to (m). The vertical axis represents the resistance value of the Warburg open circuit. As shown in FIG. 10, in the stack of Comparative Example 1, which includes the negative electrode active material layer using the spheroidized natural graphite A, almost no increase in resistance value of the Warburg open circuit, that is, ion transport resistance was observed even in the released state after the pressing. On the other hand, in the stack of Comparative Example 4, which includes the negative electrode active material layer using the uncrushed MCMB B, it was found that the resistance value Wo-R of the Warburg open circuit had been significantly increased in the released state after the pressing. This was caused by the occurrence of spring back after the pressing and thus the generation of cracks in the negative electrode active material layer in the stack of Comparative Example 4. In fact, as a result of the observation of the negative electrode active material layer in the released state, the stack of Comparative Example 1 had no remarkable cracks and accordingly maintained the shape of the negative electrode active material layer. On the other hand, in the stack of Comparative Example 4, cracks were generated everywhere and thus the impossibility of maintaining the shape as the layer were ascertained.

Subsequently, the constraining pressure on each of the stacks of Comparative Examples 1 and 4 was gradually increased from 1 tf/cm², and the manner in which the resistance value Wo-R of the Warburg open circuit changes was observed. The results are shown in FIG. 11.

FIG. 11 is a graph showing the relation between the constraining pressure and the resistance value Wo-R of the Warburg open circuit. The horizontal axis represents the constraining pressure. The vertical axis represents the resistance value Wo-R of the Warburg open circuit. The uncrushed MCMB B included in the stack of Comparative Example 4 has more excellent sphericity and mechanical properties than the spheroidized natural graphite A included in the stack of Comparative Example 1 has. Nevertheless, it was ascertained that, at the constraining pressures of less than 3 tf/cm², the stack of Comparative Example 1 has an increased resistance value Wo-R of the Warburg open circuit due to cracks in the negative electrode active material layer caused by spring back. Furthermore, it was ascertained that, at the constraining pressures of more than 3 tf/cm², the stack of Comparative Example 4 has a lower resistance value Wo-R of the Warburg open circuit than the stack of Comparative Example 1 has. This indicates that the cracks generated in the negative electrode active material layer due to the spring back were repaired by the constraining pressures of more than 3 tf/cm². However, from a practical application viewpoint, it is not realistic to apply a high pressure as high as 3 tf/cm² at the time of constraint with the constraining jig. Therefore, it is important to avoid spring back of the negative electrode active material layer by controlling not the constraining pressure but the mechanical properties of the negative electrode active material.

The verification was repeatedly performed for the correlation between the mechanical properties of the negative electrode active material as the raw particles and the occurrence of spring back. As a result, it was found that the raw particles of the negative electrode active material having an average elastic modulus of 370 MPa or less can avoid the generation of cracks in the negative electrode active material layer that would be caused by spring back.

MCMB has a firm structure by growing a graphene layer into the shape of concentric spheres. Accordingly, when becoming crushed, MCMB becomes anisotropic. MCMB having anisotropy easily becomes deformed. That is, crushing MCMB can adjust its mechanical properties. For example, as shown in Table 1, the uncrushed MCMB A of Comparative Example 3 has an average elastic modulus of 379 MPa, which is extremely high. Example 3 is the crushed MCMB C, which was obtained by finely crushing the MCMB obtained by further growing and granulating the uncrushed MCMB A of Comparative Example 3. Example 4 is the crushed MCMB D, which is crushed more finely than the crushed MCMB C of Example 3. As shown in Table 1, owing to the crushing of the MCMB, Example 3 and Example 4 were able to have respective average elastic moduli decreased to 179 MPa and 367 MPa. This results in an avoidance of spring back in Example 3 and Example 4, and accordingly it was found that the negative electrode active material layers of Example 3 and Example 4 have decreased ion transport resistance as compared with that of Comparative Example 3.

### [Charge Rate Test]

Next, a charge rate test was performed by using the battery.

### Comparative Example 5

A battery was produced, as Comparative Example 5, that includes a negative electrode active material layer using the spheroidized natural graphite A of Comparative Example 1.

### Example 5

A battery was produced, as Example 5, that includes a negative electrode active material layer using the crushed MCMB C of Example 3.

First, in both Comparative Example 5 and Example 5, the positive electrode and the negative electrode were produced by the following procedure.

The volume composition ratio of the negative electrode active material and the solid sulfide electrolyte to the total volume of the materials included in the negative electrode active material layer was set to 50%:50%, which is equal to that in the symmetric cell above. The negative electrode current collector used was a stainless steel foil.

NCM523 was used as the positive electrode active material included in the positive electrode active material layer. As the solid electrolyte included in the positive electrode active material layer, the same solid argyrodite-type sulfide electrolyte as that used in the negative electrode active material layer was used. NCM523, the solid sulfide electrolyte, a binder, a thickener, and a conductive additive were mixed in an organic solvent in a predetermined composition ratio and dispersed to prepare a positive electrode slurry. The positive electrode slurry thus obtained was applied onto the stainless steel foil as the positive electrode current collector, and a vacuum drying treatment was performed to evaporate the organic solvent. Thus, the positive electrode was produced.

As the solid electrolyte included in the solid electrolyte layer, the same solid argyrodite-type sulfide electrolyte as that used in the negative electrode active material layer was used. The weight of the solid electrolyte layer was set to 100 mg per 1 cm², which is equal to that of the symmetric cell above. The capacity of the positive electrode was set to 2.365 mAh and the weight per 1 cm² of the negative electrode active material layer was adjusted so that the capacity ratio of the positive electrode to the negative electrode was 1:1.2.

The above positive electrode and negative electrode were used to produce batteries of Comparative Example 5 and Example 5.

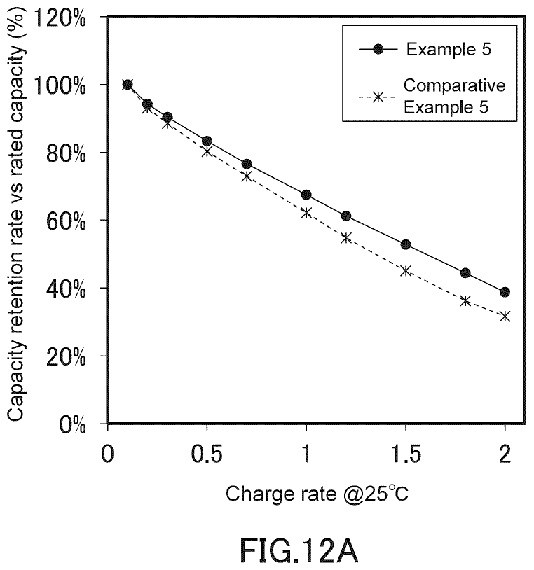

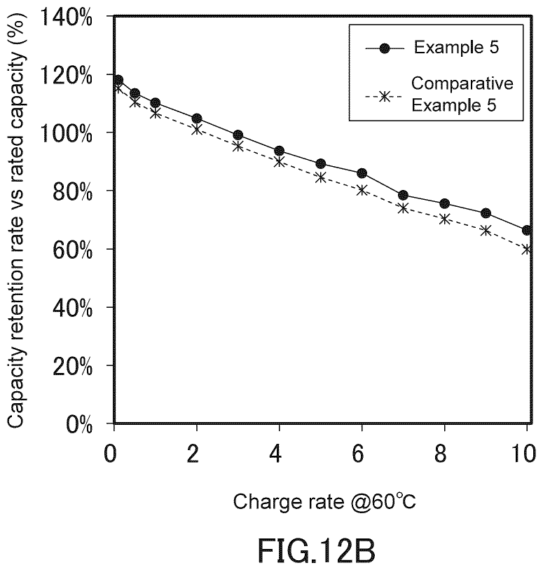

FIG. 12A is a graph showing the results of a charge rate test at 25° C. for the batteries of Comparative Example 5 and Example 5. FIG. 12B is a graph showing the results of a charge rate test at 60° C. for the batteries of Comparative Example 5 and Example 5. The horizontal axes represent the charge rate in hour rate. The vertical axes represent the capacity retention rate versus the rated capacity. Note that the rated capacity is the capacity of the battery charged at the cut-off voltage of 4.2 V at the charge rate of 0.1 C in an environment of 25° C. As shown in FIG. 12A and FIG. 12B, Example in which the sphericity and mechanical properties of the negative electrode active material were improved as compared with Comparative Example 5, the charge rate performance was enhanced. This shows that by controlling the sphericity of the negative electrode active material, deformation and orientation of the negative electrode active material due to pressure molding were suppressed, and by controlling the mechanical properties of the negative electrode active material, spring back of the negative electrode active material layer was avoided. In this manner, it was ascertained that controlling the sphericity and mechanical properties of the negative electrode active material enables the ion transport resistance of the negative electrode active material layer to be reduced.

[Charge Rate Test for Case where Volume Composition Ratio is Changed]

Next, the battery of Example 5 was subjected to a charge rate test in which the volume composition ratio of the negative electrode active material and the solid sulfide electrolyte to the total volume of the materials included in the negative electrode active material layer was changed.

### Example 6

The volume composition ratio of the negative electrode active material and the solid sulfide electrolyte to the total volume of the materials included in the negative electrode active material layer was set to 50%:50%.

### Example 7

The volume composition ratio of the negative electrode active material and the solid sulfide electrolyte to the total volume of the materials included in the negative electrode active material layer was set to 60%:40%.

### Example 8

The volume composition ratio of the negative electrode active material and the solid sulfide electrolyte to the total volume of the materials included in the negative electrode active material layer was set to 70%:30%.

### Example 9

The volume composition ratio of the negative electrode active material and the solid sulfide electrolyte to the total volume of the materials included in the negative electrode active material layer was set to 80%:20%.

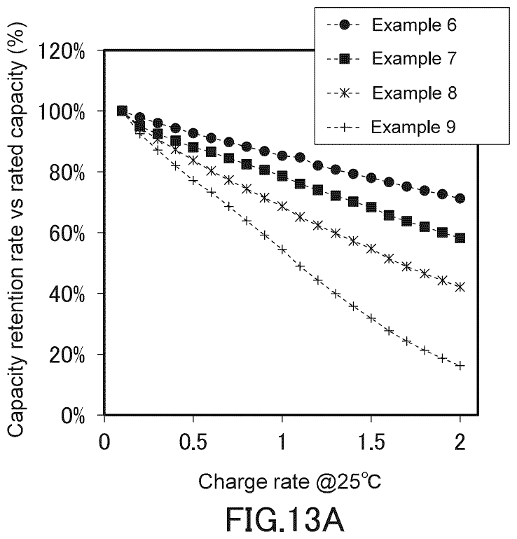

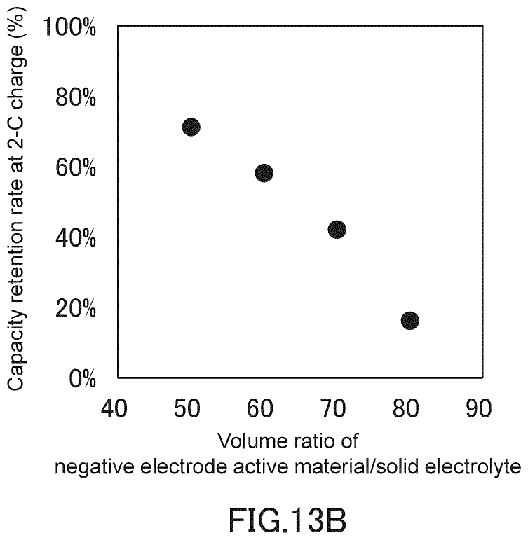

A battery was produced by the above procedure, the battery after main molding was constrained with a constraining jig at a pressure of 1.53 tf/cm², and a charge rate test at 25° C. was performed. The test results are shown in FIG. 13A and FIG. 13B.

FIG. 13A is a graph showing the results of the charge rate test at 25° C. for the batteries of Examples 6 to 9. The horizontal axis represents the charge rate in hour rate. The vertical axis represents the capacity retention rate versus the rated capacity. FIG. 13B is a graph showing the relation between the volume ratio of the negative electrode active material and the capacity retention rate for the batteries of Examples 6 to 9. The horizontal axis represents the volume ratio of the negative electrode active material. The vertical axis represents the capacity retention rate at 2-C charge. It was ascertained, as shown in FIG. 13A, that the lower the volume composition ratio of the negative electrode active material to the negative electrode active material layer is, the higher the charge rate performance is. In addition, as shown in FIG. 13B, in the range of the volume composition ratio of the negative electrode active material from 70% to 80%, a rapid deterioration in charge rate performance was observed.

### INDUSTRIAL APPLICABILITY

The all-solid-state lithium-ion secondary battery negative electrode and the all-solid-state lithium-ion secondary battery of the present disclosure are useful for electrical storage devices such as on-board lithium-ion secondary batteries.

What is claimed is:

1. A solid-state battery negative electrode comprising
a negative electrode active material layer, the negative electrode active material layer comprising a negative electrode active material and a solid electrolyte, wherein
the negative electrode active material in the negative electrode active material layer has an average aspect ratio of more than 0.5, and
the negative electrode active material has an average elastic modulus of 370 MPa or less.

2. The solid-state battery negative electrode according to claim 1, wherein
the average elastic modulus is 59 MPa or more and 370 MPa or less.

3. The solid-state battery negative electrode according to claim 1, wherein
the average aspect ratio is more than 0.5 and 0.8 or less.

4. The solid-state battery negative electrode according to claim 1, wherein
the negative electrode active material layer has a porosity of 30% or less.

5. The solid-state battery negative electrode according to claim 1, wherein
a volume composition ratio of the negative electrode active material to a total volume of materials included in the negative electrode active material layer is 50% or more and less than 70%.

6. The solid-state battery negative electrode according to claim 1, wherein
the negative electrode active material comprises a graphite.

7. The solid-state battery negative electrode according to claim 1, wherein
the solid electrolyte comprises a solid sulfide electrolyte.

8. The solid-state battery negative electrode according to claim 7, wherein
the solid sulfide electrolyte comprises at least one selected from the group consisting of a Li₂S—P₂S₅-based glass-ceramic electrolyte and a solid argyrodite-type sulfide electrolyte.

9. A solid-state battery comprising:
a positive electrode;
a negative electrode; and
a solid electrolyte layer provided between the positive electrode and the negative electrode, wherein
the negative electrode is the solid-state battery negative electrode according to claim 1.

10. A method for manufacturing a solid-state battery negative electrode, the method comprising:
mixing a negative electrode active material and a solid electrolyte to prepare a negative electrode mixture; and
pressure-molding the negative electrode mixture to obtain a negative electrode active material layer, wherein
the pressure-molding the negative electrode mixture is performed so that the negative electrode active material in the negative electrode active material layer has an average aspect ratio of more than 0.5, and
the negative electrode active material used is a negative electrode active material having an average elastic modulus of 370 MPa or less.
